(19) United States
(12) Patent Application Publication
(10) Pub. No.: US 2009/0026691 A1
(43) Pub. Date: Jan. 29, 2009

(54) SHEET CONVEYING DEVICE AND IMAGE FORMING APPARATUS

(75) Inventors: Misato Ishikawa, Tokyo (JP); Akihiko Enamito, Tokyo (JP); Yasuo Shima, Tokyo (JP); Masaki Takahashi, Tokyo (JP)

Correspondence Address: Gregory Turocy;Amin & Turocy, LLP, 24th Floor, National City Center, 1900 East 9th Street, Cleveland, OH, 44114, US

(73) Assignee: KABUSHIKI KAISHA TOSHIBA, Tokyo (JP)

(21) Appl. No.: 12/175,568

(22) Filed: Jul. 18, 2008

(30) Foreign Application Priority Data
Jul. 23, 2007 (JP) 2007-190869

(51) Int. Cl. B65H 5/06; B41F 13/64

(52) U.S. Cl. 271/10.12; 270/18

(57) ABSTRACT

A sheet conveying device includes: a pair of first rollers, the first rollers being disposed to oppose circumferential surfaces thereof with each other; a pair of second rollers, the second rollers being disposed to oppose circumferential surfaces thereof with each other; a guide plate that has a sheet conveyance face for guiding a leading edge of a sheet being conveyed in a conveying direction from the pair of first rollers toward the pair of second rollers, the guide plate being formed with one or more holes; and a sound absorbing member that is disposed on a back face of the guide plate, which opposes the sheet conveyance face, the sound absorbing member absorbing a sound transmitted through the hole formed on the guide plate.

### RELATED APPLICATION(S)

The present disclosure relates to the subject matters contained in Japanese Patent Application No. 2007-190869 filed on Jul. 23, 2007, which are incorporated herein by reference in its entirety.

### FIELD

The present invention relates to a sheet conveying device for conveying sheets such as papers by a pair of rollers and a guide in an image forming apparatus, such as an MFP (Multi Function Peripheral) and a printer.

### BACKGROUND

In an image forming apparatus, such as an MFP and a printer, sheets are fed from a sheet feeding cassette or a manual sheet feeding tray and are than conveyed to an image forming portion. A posture of the sheets to be conveyed considerably influences an image forming position on the sheets. For this reason, the sheets are positioned. In the case in which the sheets are repetitively conveyed for a color image, moreover, it is also important to position the sheets in order to prevent a color shift of an image. In order to position the sheets before the formation of the image, a registration roller pair is often used. The conveyed sheets collide with the pair of registration rollers having stationary rollers through a paper guide. In order to lead the sheets to the pair of registration rollers, a guide plate for an alignment is provided in the vicinity of the pair of registration rollers. Also after leading edges of the sheets hit upon a nip portion of the pair of registration rollers, the sheets are further conveyed through a pair of conveyance rollers. For this reason, the sheets generate a flexure and leading edges of the sheets are formed through rigidities of the sheets themselves so that all of the leading edges abut on the pair of registration rollers In a state in which all of the leading edges of the sheets abut on the pair of registration rollers, the pair of registration rollers is rotated so that the tips of the sheets are positioned based on the nip portion of the pair of registration rollers and the sheets are conveyed from the nip portion to the image forming portion.

As techniques for reducing a noise generated when conveying or positioning the sheets, there has been proposed a sheet conveying device in which an elastic guiding member, which has an edge on a side that contacts with a sheet bent in a sheet feeding direction, is provided on a conveyance path to reduce a contact of the sheet with a leading edge of the elastic member. An example of such configuration is disclosed in JP-A-8-026526.

There has also been known an image forming apparatus in which a sound absorbing member is provided on a surface near a sheet discharging portion. An example of such configuration is disclosed in JP-A-2005-227674.

There has also been proposed a printer in which a communicating hole, which causes an internal space of the printer to communicate with a space provided around a printing head, is provided on a paper guide to discharge a sound generated from the printing head from the communicating hole to the internal space. An example of such configuration is disclosed in JP-A-4-074670.

In a process for positioning the sheets, a sound is generated when the sheets hit upon the guide plate or collide with the pair of registration rollers, and acts as a noise. In order to reduce the noise generated in a conveyance path and output outward, there is a method of decreasing the number of openings such as sheet feeding ports or sheet discharging ports, reducing a size of the opening, increasing a thickness and a weight of a guide wall or reducing a sound generated in an inner part. In order to convey the sheets, however, at least the number of the openings and a size thereof are required. When the thickness and the weight of the guide wall are increased, moreover, a cost is increased. Although there is also a method of perfectly closing a conveyance path, the method increases the cost.

Therefore, there is a method of providing a sound absorbing member in the conveyance path and reducing a noise through a sound absorption of the sound absorbing member, thereby reducing a sound leaking from an inside to an outside. In the method, however, the sheets are prevented from being conveyed. For this reason, it is difficult to dispose the sound absorbing member in the conveyance path. Even if the sound absorbing member is provided on the guide wall outside of the conveyance path, moreover, the sound absorbing effect cannot be exhibited.

### SUMMARY

According to a first aspect of the invention, there is provided a sheet conveying device including: a pair of first rollers, the first rollers being disposed to oppose circumferential surfaces thereof with each other; a pair of second rollers, the second rollers being disposed to oppose circumferential surfaces thereof with each other; a guide plate that has a sheet conveyance face for guiding a leading edge of a sheet being conveyed in a conveying direction from the pair of first rollers toward the pair of second rollers, the guide plate being formed with one or more holes; and a sound absorbing member that is disposed on a back face of the guide plate, which opposes the sheet conveyance face, the sound absorbing member absorbing a sound transmitted through the hole formed on the guide plate.

According to a second aspect of the invention, there is provided an image forming apparatus including: a sheet conveying device that conveys a sheet; and an image forming section that forms an image on the sheet conveyed by the sheet conveying device, wherein the sheet conveying device includes: a pair of first rollers, the first rollers being disposed to oppose circumferential surfaces thereof with each other; a pair of second rollers, the second rollers being disposed to oppose circumferential surfaces thereof with each other; a guide plate that has a sheet conveyance face for guiding a leading edge of the sheet being conveyed in a conveying direction from the pair of first rollers toward the pair of second rollers, the guide plate being formed with one or more holes; and a sound absorbing member that is disposed on a back face of the guide plate, which opposes the sheet conveyance face, the sound absorbing member absorbing a sound transmitted through the hole formed on the guide plate.

### BRIEF DESCRIPTION OF THE DRAWINGS

In the accompanying drawings:

FIG. 1 is a schematic view showing a configuration of an image forming apparatus including a sheet conveying device according to a first embodiment of the present invention;

FIG. 2 is a view showing a main part of the sheet conveying device according to the first embodiment;

FIG. 3 is a perspective view showing the sheet conveying device according to the first embodiment;

FIG. 4 is a chart showing an example of a power spectrum of a noise generated when sheets are conveyed from a pair of intermediate conveyance rollers to a pair of registration rollers;

FIG. 5 is a chart for evaluating a sound pressure level of a sound generated from an apparatus for testing the sheet conveying device according to the first embodiment;

FIGS. 6A-6C are charts for explaining evaluation illustrated in FIG. 5, wherein FIG. 6A is a chart showing a sound pressure level for an observed sound, FIG. 6B is a chart showing a sound pressure spectrum of the sound pressure level illustrated in FIG. 6A, and FIG. 6C is a chart showing a sample data point to be a source for creating a box-and-whisker plot;

FIG. 7 is a view showing an example of an installing position of a sound level meter attached to the apparatus for testing the paper conveying device according to the first embodiment;

FIG. 8 is a perspective view showing a sheet conveying device according to a variant of the first embodiment;

FIG. 9 is a perspective view showing a sheet conveying device according to a second embodiment of the present invention;

FIG. 10 is a perspective view showing a sheet conveying device according to a variant of the second embodiment;

FIG. 11 is a perspective view showing a sheet conveying device according to a third embodiment of the present invention; and

FIGS. 12A and 12B are views showing an example of a rib structure formed on a registration guide of the sheet conveying device according to the third embodiment, wherein FIG. 12A is a plan view showing the registration guide, and FIG. 12B is a front view showing the registration guide.

### DETAILED DESCRIPTION OF THE EMBODIMENTS

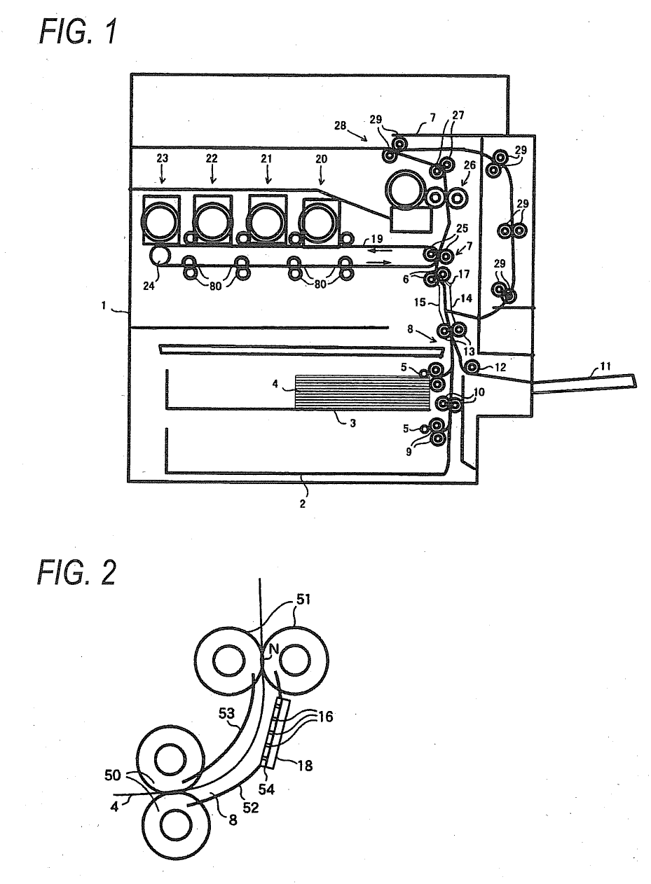

A sheet conveying device according to embodiments of the present invention will be described below with reference to FIGS. 1 to 12B. In each of the drawings, the same components are shown with the same reference numerals and repetitive description will be omitted.

### First Embodiment

FIG. 1 is a schematic view showing a configuration of an image forming apparatus including a sheet conveying device according to a first embodiment of the present invention. The sheet conveying device according to the embodiment is provided in an image forming apparatus, such as an electrophotographic apparatus. A first sheet feeding cassette 2 is provided in a lower part of a housing 1 and a second sheet feeding cassette 3 is provided above the first sheet feeding cassette 2. The second sheet feeding cassette 3 accommodates a sheet 4, which is used as an image formation medium. Pickup rollers 5 that pick up the sheet 4 are respectively provided near the first and second sheet feeding cassettes 2 and 3 on one side.

A conveyance path 8, along which the sheet 4 is conveyed, is extended upward via the second sheet feeding cassette 3, a pair of registration rollers 6 and a secondary transfer portion 7 from the first sheet feeding cassette 2 in the housing 1. A pair of sheet feeding rollers 9 for separating and feeding the sheets 4 accommodated in the second sheet feeding cassette 3 one by one and a pair of conveyance rollers 10 for interposing the separated sheet 4 therebetween and conveying the sheet 4 are provided in a lower part of the conveyance path 8. Furthermore, a manual tray 11 capable of manually feeding the sheets 4 to supply the sheets 4 to an inner part of the apparatus body is provided in the lower part of the housing 1. When the sheets 4 are mounted on the manual tray 11, the sheets 4 are fed through a manual sheet feeding roller 12 and are conveyed to the conveyance path 8.

A pair of intermediate conveyance rollers 13 for interposing and conveying the sheet 4 fed from the sheet feeding cassettes 2 and 3, and the manual tray 11 is provided in the conveyance path 8 disposed above the pair of sheet feeding rollers 9 for the second sheet feeding cassette 3. The pair of registration rollers 6 provided in the conveyance path 8 above the pair of intermediate conveyance rollers 13 once stops the sheet 4 in order to regulate a position and direction of the sheet 4 and conveys the sheet 4 to the secondary transfer portion 7. Conveyance guides 14 and 15, which have curved portions having predetermined curvatures respectively, are provided above the pair of intermediate conveyance rollers 13 and below the pair of registration rollers 6.

FIG. 2 is a view showing a main part of the sheet conveying device according to the embodiment. Each of a pair of first rollers 50 and a pair of second rollers 51 has a structure in which two rollers, each of which being a cylindrical roller, are disposed with circumferential surfaces thereof opposed to each other. As an example, the pair of first rollers 50 corresponds to the pair of intermediate conveyance rollers 13 and the pair of second rollers 51 corresponds to the pair of registration rollers 6. Guides 52 and 53 correspond to the conveyance guides 14 and 15, respectively. The curved conveyance path 8 is formed between the guides 52 and 53. The guide 52 has a sheet conveyance face for guiding a leading edge in a conveying direction of the sheet 4 conveyed from the pair of first rollers 50 to a nip portion N of the pair of second rollers 51. The sheet conveying device is provided with a guide 54 forming a part of the guide 52 and having a plurality of transmitting holes 16, and a sound absorbing member 18 disposed on a surface at an opposite side to a surface of the guide 52, which is faced toward the sheet 4. More specifically, in the sheet conveying device according to the embodiment, a hole is formed in the vicinity of the nip portion N of the pair of second rollers 51 in the guide 52, and the sound absorbing member 18 for absorbing a sound transmitted through the hole is disposed on a back face with respect to the sheet conveyance face of the guide 52.

In FIG. 2, it is also possible to employ a structure in which the pair of first rollers 50 is the pair of sheet feeding rollers 9 and the pair of second rollers 51 is the pair of conveyance rollers 10. In this case, the guide 52 serves as a guide having a sheet conveyance face for leading the leading edge in the conveying direction of the sheet 4 conveyed from the pair of sheet feeding rollers 9 serving as the pair of first rollers 50 to the nip portion N of the pair of conveyance rollers 10 serving as the pair of second rollers 51 (which will be hereinafter referred to as a sound absorbing guide).

When the sheet 4 is conveyed, a sound is generated when the sheet 4 hits upon the guides 52 and 53 or a sound is generated when the sheet 4 collides with the pair of second rollers 51. In the sheet conveying device according to the embodiment, however, the conveyance guide (or the sound absorbing guide) and the sound absorbing member 18 are provided to decrease noises generated during the conveyance of the sheet 4 and transmitted from the conveyance path 8 to an outside, for example, the hitting sound and the colliding sound. Moreover, the same noises as those of the pair of intermediate conveyance rollers 18 and the pair of registration rollers 6 are also generated through a conveyance between the pair of sheet feeding rollers 9 and the pair of conveyance rollers 10. By providing a mechanism for forming a hole on the guide 52 in the vicinity of the nip portion N of the pair of second rollers 51 and disposing the sound absorbing member 18 on a back side with respect to the sheet conveyance face of the guide 52, however, it is also possible to reduce the noises.

In the sheet conveying device according to the embodiment, the transmitting hole 16 for transmitting a sound is provided on the guide 52 for leading the sheet 4, and the sound absorbing member 18 is disposed at a place to which the sound is transmitted. Thus, the generated noises are reduced without inhibiting the conveyance of the sheet 4. A sound generated in the conveyance path 8 formed by the guides 52 and 53 is reflected in the conveyance path 8. There are generated sounds to be transmitted directly from the inner part of the conveyance path 8 to the outside of the conveyance path 8 via a gap between the roller pairs such as the pair of first rollers 50 and the pair of second rollers 51 or the guides serving as the conveyance guides 14 and 15 or the sound absorbing guides. In addition to the sounds, there are generated a sound to be transmitted through the guide and a sound to be reflected by the guide and returned into the conveyance path 8.

The conveyance path 8 formed by the conveyance guides 14 and 15 or the guides serving as the sound absorbing guides has a small number of openings and almost forms a closed space. If a sound insulating effect obtained by using the conveyance guide (or the sound absorbing guide) provided with the transmitting hole 16 and the sound absorbing member 18 is equivalent to or more than a sound insulating effect obtained by using an ordinary guide in the conveyance path 8, an effect for reducing a reflected sound which is generated in the conveyance path 8, reflected by the guide and returned into the conveyance path 8 is higher in the conveyance guide (or the sound absorbing guide) having the transmitting hole 16 and the sound absorbing member 18 disposed on the back side of the conveyance path 8 than that of the ordinary guide. Therefore, it is possible to reduce the noise generated in the conveyance path 8 and transmitted to the outside of the conveyance path 8.

It is also possible to provide the sound absorbing member 18 on the back side of the conveyance path 8 and to provide the guide wall and the housing in opposed positions to the conveyance path 8 along the surface of the conveyance path 8. Also in this case, a sound absorbing effect can be produced. If an air layer is provided between the sound absorbing member 18 and the guide wall or housing, it is possible to increase the sound absorbing effect within a frequency range reaching a lower tone depending on a thickness of the air layer.

Image forming units 20, 21, 22 and 23 for transferring and forming toner images having respective colors of yellow, magenta, cyan and black onto a non-end transfer belt 19 are arranged in a central part of the housing 1 in FIG. 1. Toner images are formed on the transfer belt 19 through four developing rollers 80. The transfer belt 19 is rotated and run in a counterclockwise direction through a motor for driving a drive roller 24. A pair of secondary transfer rollers 25 interposes the sheet 4 fed from the pair of registration rollers 6 together with the transfer belt 19, and at the same time, transfers, to the sheet 4, a color toner image transferred onto the transfer belt 19. In the conveyance path 8, a fixing portion 26 for fixing the transferred toner image onto the sheet 4 is provided in a position on a downstream side in the sheet conveying direction from the pair of secondary transfer rollers 25. The image transferred onto the sheet 4 is heated and pressurized in the fixing portion 26 and is conveyed to a sheet discharging portion 28 through a pair of sheet discharging rollers 27. Four pairs of conveyance rollers 29 for conveying the sheet 4 with both sides inverted are provided along a side face of the housing 1 from a termination of the conveyance path 8. The sheet 4 reaching the termination of the conveyance path 8 is returned toward an upstream side of the pair of registration rollers 6 via the pair of conveyance rollers 29 so that the toner image on the transfer belt 19 is also transferred onto a back face of the sheet 4.

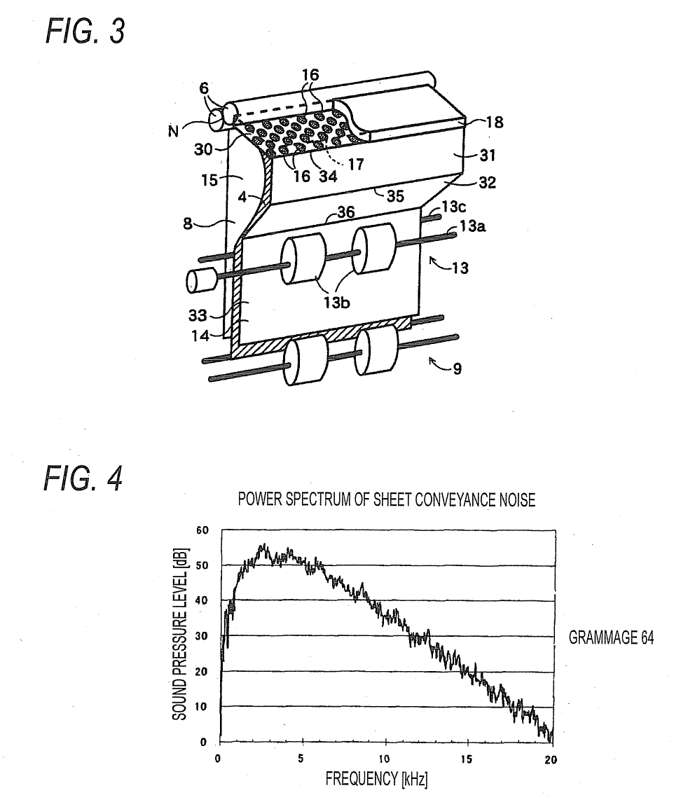

FIG. 3 shows an example of the sheet conveying device provided in the image forming apparatus. FIG. 3 is a perspective view showing the sheet conveying device according to the embodiment. The sheet conveying device includes the pair of sheet feeding rollers 9 for taking the sheet 4 out of the second sheet feeding cassette 3 and conveying the sheet 4, the pair of intermediate conveyance rollers 13 for interposing and conveying the sheet 4 discharged from the pair of sheet feeding rollers 9, the pair of registration rollers 6 for flexing the sheet 4 which is conveyed, thereby performing a skew correction for the sheet 4, the conveyance guide 14 for leading the sheet 4 from the pair of intermediate conveyance rollers 13 to the pair of registration rollers 6, a registration guide 17 serving to lead the sheet 4 from the pair of intermediate conveyance rollers 13 to the pair of registration rollers 6 and provided with the transmitting hole 16 in a portion on which the flexed sheet 4 abuts, and the sound absorbing member 18 provided on the registration guide 17.

The pair of intermediate conveyance rollers 13 is configured by a driving roller including a plurality of roller portions 13b formed of a rubber and attached apart from a roller shaft 13a, and a driven roller 13c caused to be in pressure contact with the sheet 4. The pair of registration rollers 6 is configured by a driving roller, which is formed of a rubber, and a driven roller, which is formed of a metal. The conveyance guide 14 is configured by faces 30, 31, 32 and 33 and has bent portions 34, 35 and 36. A sectional shape in a longitudinal direction of the conveyance guide 14 forms an asymptote in the sheet conveying direction from the pair of intermediate conveyance rollers 13 to the nip portion N of the pair of registration rollers 6. It is apparent that the face 30 is positioned to lead the sheet 4 to the nip portion N of the pair of registration rollers 6 (or in the vicinity of the nip portion N) and is provided on a downstream end in the sheet conveying direction. The face 30 is provided with the sound absorbing member 18. More specifically, a hole is formed in the vicinity of the nip portion N to be a gap of the pair of registration rollers 6 to which the sheet 4 is led in the conveyance guide 14. An upper end of the conveyance guide 15 is positioned to lead the sheet 4 to the nip portion N of the pair of registration rollers 6 (or in the vicinity of the nip portion N), and is formed integrally with an almost suspended face from the upper end. A guide is not provided in the nip portion N of the pair of registration rollers 6 but is provided in a position placed slightly apart from the nip portion N.

In the image forming apparatus including the sheet conveying device according to the embodiment which has the structure, a driving control portion (not shown) serves to control each of rotating speeds of the driving rollers of the pair of registration rollers 6 and the driving rollers of the pair of intermediate conveyance rollers 13 in such a manner that a predetermined number of sheets 4 are conveyed by means of the pair of intermediate conveyance rollers 13 in a state in which the rotation of the rollers of the pair of registration rollers 6 is stopped. The conveyance guide 14 causes a leading edge in a discharging direction of the sheet 4 discharged from the pair of intermediate conveyance rollers 13 to come in sliding contact with a curved surface, thereby curling the sheet 4. Then, the driving control portion continuously performs the conveyance until the leading edge in the discharging direction of the sheet 4 discharged from the pair of intermediate conveyance rollers 13 hits upon the nip portion N of the pair of registration rollers 6 and the sheet 4 is slightly flexed, and thereafter stops the conveying operation. Accordingly, a posture of the sheet 4 is arranged so that the skew of the sheet 4 is corrected. Consequently, the leading edge of the sheet 4 is positioned.

In a direction in which the conveyance guide 14 is seen from the conveyance path 8, a sound is discharged to the back side of the conveyance path 8 via the transmitting holes 16, and the sound absorbing member 18 is stuck onto the conveyance guide 14 to be a place to which the sound is discharged. A sound generated when the sheet 4 hits upon the pair of registration rollers 6 is absorbed by the sound absorbing member 18. The transmitting holes 16 are formed intensively in a predetermined region on the face 30. For this reason, the sound generated in the conveyance path 8 is absorbed in only one place.

Moreover, the transmitting holes 16 and the sound absorbing member 18 are provided on the registration guide 17 which is close to a sound source. Therefore, there are reduced noises generated in the conveyance path 8 and transmitted to the outside of the conveyance path 8 when the sheet 4 is to be positioned, for example, a sound generated when the sheet 4 hits upon the registration guide 17 and a collision sound of the sheet 4 with the pair of registration rollers 6. The sound absorbing member 18 is disposed in a place to which the sound is transmitted or discharged. Therefore, the conveyance of the sheet 4 is not blocked.

It is possible to obtain equivalent advantages in a smaller area of the guide including the transmitting hole 16 and the sound absorbing member 18 disposed on the back face of the conveyance path 8 in the transmitting hole 16 which is proposed in the embodiment if the guide is closer to the sound source. By providing the transmitting hole 16 on the registration guide 17 in the vicinity of the pair of registration rollers 6 which is the closest to the sound source and disposing the sound absorbing member 18, accordingly, it is possible to obtain the effect of reducing the noises at a low cost.

Moreover, the sound absorbing member 18 is selected corresponding to a frequency characteristic of the noise to be reduced. FIG. 4 is a chart showing an example of a power spectrum for a noise generated when the sheet is conveyed from the pair of intermediate conveyance rollers 13 to the pair of registration rollers 6. According to an experiment, for example, a power spectrum is obtained as shown in FIG. 4 after a processing of performing a background noise correction in an A-characteristic in the case in which a sheet having a grammage of 64 [g/m²] is conveyed from the pair of intermediate conveyance rollers 13 and is caused to collide with the pair of registration rollers 6. In this case, a sound pressure level in a frequency range of 1 kHz to 9 kHz is high. In the example of the experiment, consequently, it is effective to use the sound absorbing member 18 for absorbing a sound in a frequency range of approximately 2 kHz or the sound absorbing member 18 for absorbing a sound in a frequency range of approximately 1 kHz.

The sound absorbing member has various types, that is, a member having a characteristic that a high sound absorbing effect is obtained at 1 kHz and a member having a characteristic that a high sound absorbing effect is obtained at 2 kHz. The sound absorbing member 18 used in the experiment has such a characteristic as to absorb a sound by setting a frequency component of 2 kHz as a peak. By providing the sound absorbing member specialized to have the characteristic in the frequency range, therefore, it is possible to absorb a sound by setting, as a target, a frequency region having a high sound pressure level of 2 to 5 kHz or 1 to 8 kHz. Consequently, it is possible to obtain a great effect of reducing the sound.

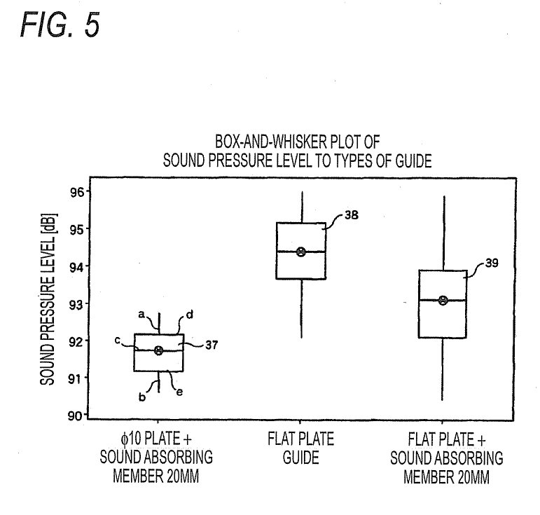

By using a conveyance element testing device including conveyance elements from the pair of intermediate conveyance rollers 13 to the pair of registration rollers 6 in the sheet conveying device according to the embodiment, three types of registration guides were exchanged to execute a control experiment. An environment and a condition for the experiment will be described below. When the three types of registration guides were exchanged to measure a sound pressure level, a result shown in FIG. 5 was obtained. FIG. 5 is a chart for evaluating a sound pressure level of a sound generated from the conveyance element testing device. A box-and-whisker plot shown in FIG. 5 illustrates three boxes 37, 38 and 39 representing a distribution of data observed by using the respective registration guides.

Each of the boxes 37 to 39 represents a distribution of data drawn based on an overall value (OA value) corresponding to an energy of an observed sound. The box 37 represents a distribution of an overall value for a registration guide in which the transmitting hole 16 is formed and the sound absorbing member 18 is provided on the transmitting hole 16. The box 38 represents a distribution of an overall value in the case in which a flat plate having no transmitting hole 16 formed thereon and provided with no sound absorbing member 18 is used as a registration guide. The box 39 represents a distribution of an overall value in the case in which a flat plate having no transmitting hole 16 formed thereon and provided with the sound absorbing member 18 is used as the registration guide. The box 37 has vertical lines “a” and “b” on upper and lower sides respectively. An upper end of the vertical line “a” indicates a maximum value in a zone and a lower end of the vertical line “b” indicates a minimum value in the zone. A vertical line “c” on a center of the box 37 indicates a median in the zone. Transverse lines “d” and “e” vertically surround the transverse line “c” respectively, and the transverse line “d” indicates a value obtained by adding a deviation to the median and the transverse line “e” indicates a value obtained by subtracting the deviation from the median. The boxes 38 and 39 are the same.

In a comparison between the boxes 37 and 38, a noise reducing effect of 2 to 4 dB was observed in a conveyance element testing device using a registration guide provided with the transmitting hole 16 having a diameter of 10 mm and the sound absorbing member 18 which is disposed on the back face of the conveyance path 8. In a comparison between the boxes 38 and 39, the noise reducing effect can be obtained also in the case in which the transmitting hole 16 is not formed but only the sound absorbing member 18 is provided. However, it is apparent that the noise reducing effect in the case in which the transmitting hole 16 and the sound absorbing member 18 are provided is greater than that in the case in which only the sound absorbing member 18 is provided.

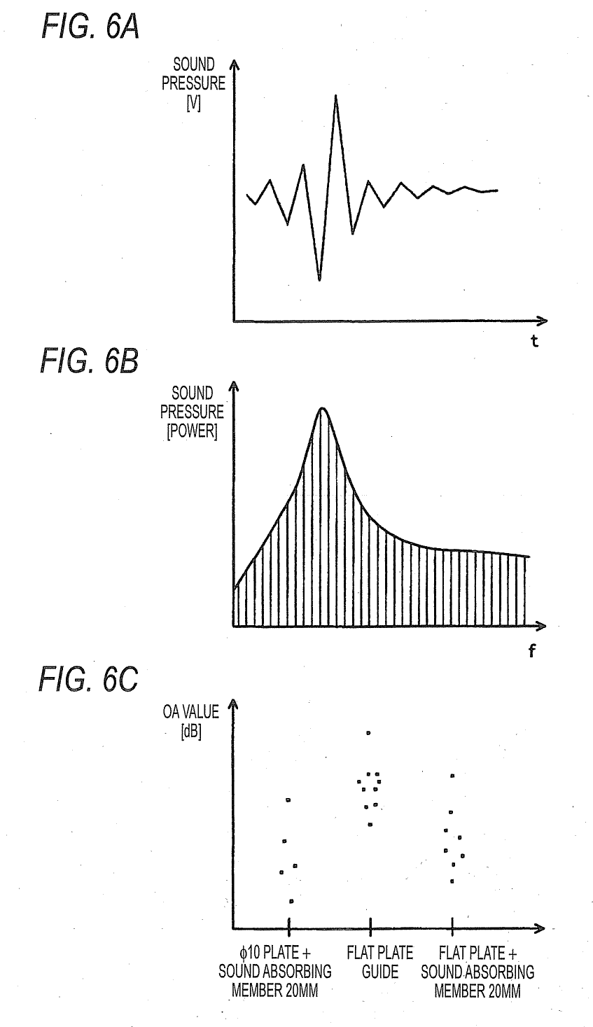

A method of obtaining the plot shown in FIG. 5 will be described with reference to FIGS. 6A-6C. FIG. 6A is a chart showing a sound pressure level (a voltage V) for an observed sound, and FIG. 6B is a chart showing a sound pressure spectrum (power) having the sound pressure level illustrated in FIG. 6A. FIG. 6C is a chart showing a sample data point to be a basis for creating a box-and-whisker plot. A spectrum waveform shown in FIG. 6B is divided into a plurality of frequency ranges and peak values in the respective frequency ranges are added to calculate an overall value. In an observation for a sound generated from the conveyance element testing device, the overall value is plotted as one point as shown in FIG. 6C. Referring to 20 sample data obtained by 20 observations on the same condition through an observer, outliers appearing on both ends of a distribution curve in the sample data are eliminated. Points of 50% of the 20 sample data are plotted into a box-and-whisker plot so that the boxes 37 to 39 shown in FIG. 5 are obtained. More specifically, the boxes 37 to 39 include values related to the corresponding points to 50% of the 20 points, respectively.

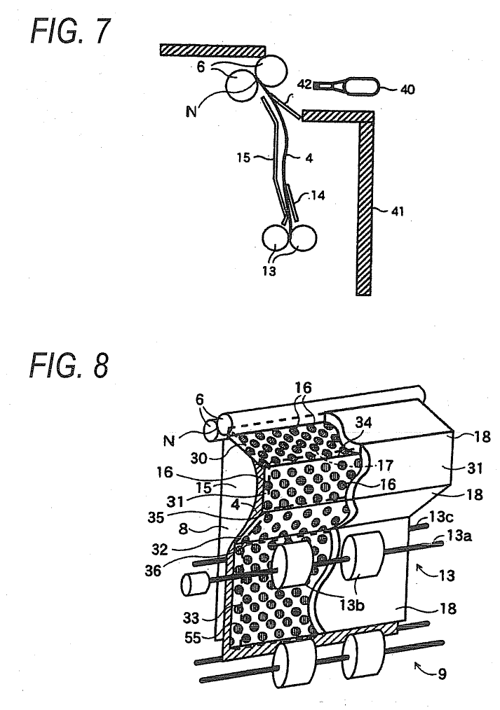

FIG. 7 is a view showing an example of a position in which a sound level meter is provided in a measurement of a noise. In order to execute an experiment in the example shown in FIG. 5, a measurement was carried out in a state in which a sound level meter 40 is provided in a position shown in FIG. 7 and is covered with a wall 41 for preventing a wraparound of a sound from a separate part from the conveyance path 8. A paper was conveyed at a speed of 400 [mm/s] and a noise generated in a flexure of the paper due to a collision with the pair of registration rollers 6 was extracted by using the sound level meter 40. 42 denotes a registration guide, and a combination of the experiments through an exchange of the registration guide 42 and the sound absorbing member will be described in the following (1) to (3).

(1) A flat plate

(2) A flat plate and a sound absorbing member having thickness of 20 mm

(3) A perforated flat plate having a diameter of 10 mm (φ10) and a sound absorbing member having a thickness of 20 mm

A material of a registration guide which was used is the Zincoat (registered trademark) material, and has a thickness of 1.2 [m] and a shape of 300×32 [m]. A hole array is 60 degrees zigzag blanking, and all of a material, a thickness and a guide area are identical. A porosity of the φ10 perforated flat plate is 0.40. The sound absorbing member which was used is VD Form manufactured by Bridgestone Corporation which serves to absorb a sound in a frequency range of approximately 1 kHz and has a thickness of 20 mm (VD1020D). A target sheet has a grammage of 64 [g/m²]. The sheet was conveyed 20 times to measure a collision sound and a value obtained by averaging the overall values was set to be a result of the experiment. Every time the paper was conveyed five times, it was exchanged for a new paper.

According to the image forming apparatus in accordance with the embodiment, by providing the conveyance guide 14 having the transmitting hole 16 and the sound absorbing member 18, it is possible to reduce the noises generated when conveying the sheet 4 and transmitted to the outside of the conveyance path 8, for example, the sound generated when the sheet 4 hits upon the conveyance guides 14 and 15 and the collision sound of the sheet 4 with the pair of registration rollers 6. Accordingly, the hole is formed in the close position to the sound source and the sound absorbing member 18 is attached to absorb the sound. Therefore, it is possible to reduce the sound without increasing a cost. Moreover, the sound absorbing member 18 is not provided in the conveyance path 8. Consequently, it is possible to reduce the noise without blocking the conveyance of the sheet 4.

Thus, the transmitting hole 16 for transmitting a sound is provided on the guide for leading the sheet 4 and the sound absorbing member 18 is disposed in the place to which the sound is transmitted. Consequently, it is possible to reduce the generated noise without blocking the conveyance of the sheet 4. Moreover, it is possible to reduce the noise at a low cost.

Variant of First Embodiment

A transmitting hole 16 may be formed over a whole surface of a guide plate. FIG. 8 is a perspective view showing a sheet conveying device according to a variant of the first embodiment in accordance with the invention. The sheet conveying device includes an pair of intermediate conveyance rollers 13 and a pair of registration rollers 6, each of which has two cylindrical rollers disposed with circumferential surfaces thereof opposed to each other, a conveyance guide 55 having a sheet conveyance face for leading, to the pair of registration rollers 6, a leading edge in a conveying direction of a sheet 4 conveyed from the pair of intermediate conveyance rollers 13 and having the transmitting hole 16 formed thereon, and a sound absorbing member 18 for absorbing a sound transmitted through the transmitting hole 16 formed on a back face with respect to the sheet conveyance face of the conveyance guide 55. The conveyance guide 55 has faces 30, 31, 32 and 33 and bent portions 34, 35 and 36. The transmitting hole 16 is formed on the faces 30 to 33, and the sound absorbing member 18 is provided on a back side of the faces 30 to 33 with respect to the sheet conveyance face. Accordingly, the hole is formed on the whole surface of the conveyance guide 55. In FIG. 8, elements having the same reference numerals as those illustrated in FIG. 3 are identical to the elements.

Also in an image forming apparatus including the sheet conveying device according to the variant of the first embodiment in accordance with the invention which has the structure, a sound generated when the sheet 4 hits upon the conveyance guide 55 or a conveyance guide 15 and a sound generated through a collision of the sheet 4 with the pair of registration rollers 6 are discharged to a back side of a conveyance path 8 via the transmitting hole 16 formed over the whole surface of the conveyance guide 55 in the conveyance of the sheet 4 from the pair of intermediate conveyance rollers 13 to the pair of registration rollers 6. The sound absorbing member 18 is provided over the whole surface of the conveyance guide 55 and absorbs the sounds.

According to the sheet conveying device in accordance with the variant of the invention, the noise transmitted from an inside of the conveyance path 8 to an outside of the conveyance path 8 is reduced, and furthermore, a sound absorbing effect can be enhanced still more.

Guide plates corresponding to the conveyance guides 15 and 55 may be provided in the conveyance path 8 between a pair of sheet feeding rollers 9 and a pair of conveyance rollers 10. Thus, it is possible to decrease the noises generated between the pair of sheet feeding rollers 9 and the pair of conveyance rollers 10.

### Second Embodiment

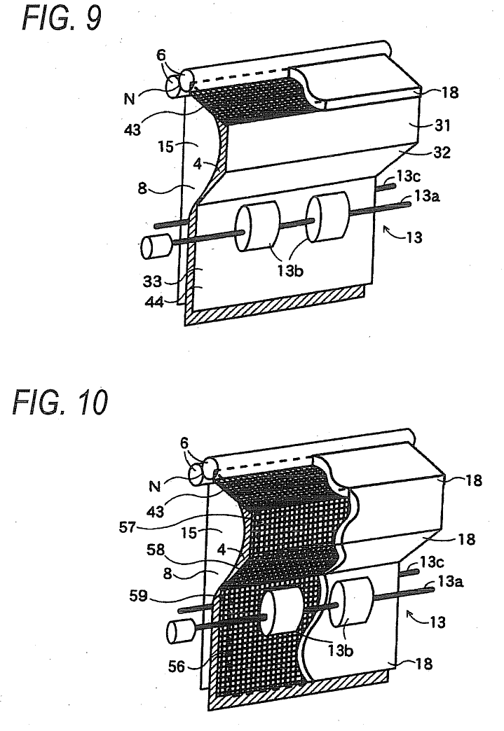

FIG. 9 is a perspective view showing a sheet conveying device according to a second embodiment of the present invention. The sheet conveying device according to the embodiment includes an pair of intermediate conveyance rollers 13 for interposing and conveying a sheet 4 discharged from a pair of sheet feeding rollers which is not shown, a pair of registration rollers 6 for flexing the sheet 4 which is conveyed, thereby performing a skew correction for the sheet 4, a conveyance guide 15 for leading the sheet 4 from the pair of intermediate conveyance rollers 13 to the pair of registration rollers 6, a registration guide 43 serving to lead the sheet 4 from the pair of intermediate conveyance rollers 13 to the pair of registration rollers 6 and including a portion having a meshed structure on which the flexed paper 4 abuts, and a sound absorbing member 18 provided on the registration guide 43.

The registration guide 43 is configured by a plurality of wires, and the wires are intersected or entangled with each other to form a mesh so that the registration guide 43 has a plate shape as a whole. A conveyance guide 44 is configured by the registration guide 43 and faces 31, 32 and 33. More specifically, the meshed structure is formed in the vicinity of a nip portion N to be a gap of the pair of registration rollers 6 to which the sheet 4 is led in the conveyance guide 44. In FIG. 9, elements having the same reference numerals as those described above are identical or substantially the same with the described elements. The sheet conveying device according to the embodiment is provided in the portion in the image forming apparatus as such described in the first embodiment.

In the image forming apparatus including the sheet conveying device configured as described above, a sound generated when the sheet 4 hits upon the conveyance guide 44 or the conveyance guide 15 and a sound generated due to a collision of the sheet 4 with the pair of registration rollers 6 are discharged to a back side of a conveyance path 8 via a void of the registration guide 43 in the conveyance of the sheet 4 from the pair of intermediate conveyance rollers 13 to the pair of registration rollers 6. The sound absorbing member 18 absorbs the sounds. Consequently, there is reduced a noise transmitted from an inside of the conveyance path 8 to an outside of the conveyance path 8.

According to the sheet conveying device, it is possible to use, as the registration guide 43, a component which does not include a manufacturing process for forming a transmitting hole on a plate-shaped member. According to the sheet conveying device, moreover, it is possible to decrease a noise generated in the conveyance path 8 without blocking the conveyance of the sheet 4.

Guide plates corresponding to the conveyance guides 15 and 44 may be provided in the conveyance path 8 between a pair of sheet feeding rollers 9 and a pair of conveyance rollers 10. Thus, it is possible to decrease the noises generated between the pair of sheet feeding rollers 9 and the pair of conveyance rollers 10.

Variant of Second Embodiment

A meshed structure may be formed over a whole surface of a guide plate. FIG. 10 is a perspective view showing a sheet conveying device according to a variant of the second embodiment. The sheet conveying device includes an pair of intermediate conveyance rollers 13 and a pair of registration rollers 6, each of which has two rollers to be cylindrical rotors disposed with circumferential surfaces thereof opposed to each other, a conveyance guide 56 having a sheet conveyance face for leading, to the pair of registration rollers 6, a leading edge in a conveying direction of a sheet 4 conveyed from the pair of intermediate conveyance rollers 13 and having a meshed structure formed thereon, and a sound absorbing member 18 for absorbing a sound transmitted through the meshed structure of the conveyance guide 56.

The conveyance guide 56 is configured by a registration guide 43 and registration guides 57, 58 and 59. Each of the registration guides 57, 58 and 59 is formed by a plurality of wires and is configured by intersecting or entangling the wires with each other to form a mesh. More specifically, the meshed structure is formed over a whole surface of the conveyance guide 56. Moreover, the sound absorbing member 18 is provided on each of back sides of the registration guides 43, 57, 58 and 59 with respect to the sheet conveyance face. In FIG. 10, elements having the same reference numerals as those illustrated in FIG. 9 are identical or substantially the same with the elements described in the second embodiment.

In an image forming apparatus including the sheet conveying device according to the variant of the second embodiment of the invention which has the structure, a sound generated when the sheet 4 hits upon the conveyance guide 56 or a conveyance guide 15 and a sound generated due to a collision of the sheet 4 with the pair of registration rollers 6 are discharged to a back side of a conveyance path 8 via the registration guides 43, 57, 58 and 59 having the meshed structure formed over the whole surface of the conveyance guide 56 in the conveyance of the sheet 4 from the pair of intermediate conveyance rollers 13 to the pair of registration rollers 6. The sound absorbing member 18 provided on a back face of each of the registration guides 43, 57, 58 and 59 absorbs the sounds.

According to the sheet conveying device in accordance with the variant, it is possible to use, as the conveyance guide 56, a component which does not include a manufacturing process for forming a transmitting hole on a plate-shaped member, and a noise transmitted from an inside of the conveyance path 8 to an outside of the conveyance path 8 is reduced so that a sound absorbing effect can be enhanced still more.

Guide plates corresponding to the conveyance guides 15 and 56 may be provided in the conveyance path 8 between a pair of sheet feeding rollers 9 and a pair of conveyance rollers 10. Thus, it is possible to decrease the noises generated between the pair of sheet feeding rollers 9 and the pair of conveyance rollers 10.

### Third Embodiment

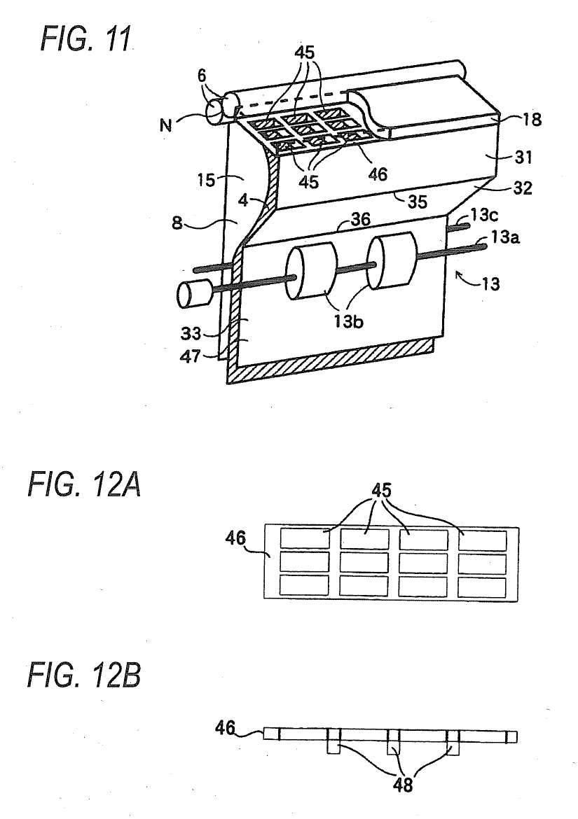

FIG. 11 is a perspective view showing a sheet conveying device according to a third embodiment of the present invention. The sheet conveying device according to the embodiment includes an pair of intermediate conveyance rollers 13 for interposing and conveying a sheet 4 discharged from a pair of sheet feeding rollers which is not shown, a pair of registration rollers 6 for flexing the sheet 4 which is conveyed, thereby performing a skew correction for the sheet 4, a registration guide 46 serving to lead the sheet 4 from the pair of intermediate conveyance rollers 13 to the pair of registration rollers 6 and provided with a plurality of hole portions 45 to be transmitting portions in a portion on which the flexed paper 4 abuts, and having a rib provided on a surface turned toward a conveyance path 8, and a sound absorbing member 18 provided on an opposite surface to the surface on which the rib of the registration guide 46 is erected.

A conveyance guide 47 is configured by the registration guide 46 and faces 31, 32 and 33. More specifically, a hole portion is formed in the vicinity of a nip portion N of the pair of registration rollers 6 in the conveyance guide 47, and furthermore, the sound absorbing member 18 for absorbing a sound transmitted through the hole portion is disposed on a surface of the conveyance guide 47 at a back side of a sheet conveyance face and the rib is formed on the sheet conveyance face. In FIG. 11, elements having the same reference numerals as those in the description are identical or substantially the same with the elements previously described. The sheet conveying device according to the embodiment is also provided in a portion constituting the sheet conveying device of the image forming apparatus described in the first embodiment.

FIGS. 12A and 12B are views showing an example of a rib structure formed on the registration guide 46 in the sheet conveying device according to the embodiment. FIG. 12A is a plan view showing the registration guide 46, and a plurality of hole portions 45 is formed at a regular interval in vertical and transverse directions of the plate-shaped registration guide 46. FIG. 12B is a front view showing the registration guide 46. A plurality of, for example, three ribs 48 extended in a depth direction seen from a front are provided apart from each other on a back face of the registration guide 46. The ribs 48 are provided along corresponding positions under portions of the registration guide 46 in which the hole portions 45 are not formed. In the case in which the registration guide 46 is attached to the sheet conveying device, moreover, a longitudinal direction of each of the ribs 48 is coincident with a sheet conveying direction and a direction in which the ribs 48 are provided apart from each other is coincident with a transverse direction of the conveyance path 8. An interval between two adjacent ribs 48 is equal to a length of a long side of the hole portion 45 and is set to be smaller than a width of the conveyance path 8. Also in the case in which a skew is generated during a conveyance, a height of the rib 48 is determined in such a manner that a position of a corner portion of the sheet 4 does not enter an inner part of any of the hole portions 45.

In an image forming apparatus including the sheet conveying device, the sheet 4 discharged from the pair of intermediate conveyance rollers 13 is conveyed toward the pair of registration rollers 6 while a leading edge in a discharging direction thereof comes in sliding contact with each of surfaces of the faces 33, 32 and 31 constituting the conveyance guide 47. Each of the ribs 48 supports a surface of the sheet 4 in sliding contact therewith from above toward the conveyance path 8. Moreover, a sound generated when the sheet 4 hits upon the conveyance guide 47 or a conveyance guide 15 and a sound generated due to a collision of the sheet 4 with the pair of registration rollers 6 are discharged to a back side of the conveyance path 8 via the hole portions 45 in the conveyance of the sheet 4 from the pair of intermediate conveyance rollers 13 to the pair of registration rollers 6. The sound absorbing member 18 absorbs the sounds. Consequently, there is reduced a noise transmitted from an inside of the conveyance path 8 to an outside of the conveyance path 8.

Also in the case in which the registration guide 46 on which the hole portions 45 having large opening sizes or a large number of hole portions 45 are formed is attached to the sheet conveying device according to the embodiment, furthermore, the corner portion of the sheet 4 is not caught on the hole portions 45 but the sheet 4 is conveyed in an abutting state on a top portion of the rib 48 because the rib 48 is provided.

According to the sheet conveying device in accordance with the embodiment of the invention, thus, it is possible to enlarge the transmitting portion for discharging the sound. According to the sheet conveying device, moreover, it is possible to reduce a noise generated in the conveyance path 8 without blocking the conveyance of the sheet 4.

Guide plates corresponding to the conveyance guides 15 and 47 may be provided in the conveyance path 8 between a pair of sheet feeding rollers 9 and a pair of conveyance rollers 10. Thus, it is possible to decrease the noises generated between the pair of sheet feeding rollers 9 and the pair of conveyance rollers 10.

The present invention is not exactly limited to the embodiments described above but the components can be deformed and embodied without departing from the scope of the claimed invention. Although the sectional shapes of the guides 52 and 53 in the conveying direction are concave and convex with respect to the conveyance path 8 respectively in FIG. 2, they can be varied depending on the positions in which the pair of first rollers 50 and the pair of second rollers 51 are disposed. It is possible to variously change the shapes, sizes, positions and numbers of the transmitting holes 16 in FIGS. 3 and 8 and the hole portions 45 in FIG. 11A. For the meshed structure in FIGS. 9 and 10, it is possible to use various structures formed by a plurality of wires like a mesh. In the embodiments, it is also possible to form a notch portion in an edge part of the registration guide in place of the hole or the hole portion and to provide the sound absorbing member on the back side of the conveyance path of the registration guide in order to cover the notch portion. For the invention employing the notch portion, similarly, the advantages of the invention can be prevented from being deteriorated.

The components described in the embodiments may be combined as necessary. For example, it is also possible to delete some of all the components described in the embodiments. Furthermore, it is also possible to properly combine the components in the different embodiments from each other.

What is claimed is:

1. A sheet conveying device comprising:
a pair of first rollers, the first rollers being disposed to oppose circumferential surfaces thereof with each other;
a pair of second rollers, the second rollers being disposed to oppose circumferential surfaces thereof with each other;
a guide plate that has a sheet conveyance face for guiding a leading edge of a sheet being conveyed in a conveying direction from the pair of first rollers toward the pair of second rollers, the guide plate being formed with one or more holes; and
a sound absorbing member that is disposed on a back face of the guide plate, which opposes the sheet conveyance face, the sound absorbing member absorbing a sound transmitted through the hole formed on the guide plate.

2. The device according to claim 1, wherein the guide plate is formed to have a meshed structure.

3. The device according to claim 1, wherein the guide plate is formed with the holes at a position near a nip portion where a gap is formed between the second rollers, toward which the sheet is guided.

4. The device according to claim 1, wherein the guide plate is formed with a plurality of the holes at an area overall the guide plate.

5. An image forming apparatus comprising:
a sheet conveying device that conveys a sheet; and
an image forming section that forms an image on the sheet conveyed by the sheet conveying device,
wherein the sheet conveying device includes:
a pair of first rollers, the first rollers being disposed to oppose circumferential surfaces thereof with each other;
a pair of second rollers, the second rollers being disposed to oppose circumferential surfaces thereof with each other;
a guide plate that has a sheet conveyance face for guiding a leading edge of the sheet being conveyed in a conveying direction from the pair of first rollers toward the pair of second rollers, the guide plate being formed with one or more holes; and
a sound absorbing member that is disposed on a back face of the guide plate, which opposes the sheet conveyance face, the sound absorbing member absorbing a sound transmitted through the hole formed on the guide plate.

6. The apparatus according to claim 5, wherein the guide plate is formed to have a meshed structure.

7. The apparatus according to claim 5, wherein the guide plate is formed with the holes at a position near a nip portion where a gap is formed between the second rollers, toward which the sheet is guided.

8. The apparatus according to claim 5, wherein the guide plate is formed with a plurality of the holes at an area overall the guide plate.
